(19) United States
(12) Patent Application Publication
(10) Pub. No.: US 2011/0123023 A1
(43) Pub. Date: May 26, 2011

(54) APPARATUS FOR VIDEO ENCRYPTION BY RANDOMIZED BLOCK SHUFFLING AND METHOD THEREOF

(75) Inventors: Su-Gil CHOI, Daejeon (KR); Geon-Woo KIM, Daejeon (KR); Jong-Wook HAN, Daejeon (KR); Hyun-Sook CHO, Daejeon (KR); Myung-Joon KIM, Daejeon (KR)

(73) Assignee: Electronics and Telecommunications Research Institute, Daejeon-city (KR)

(21) Appl. No.: 12/908,374

(22) Filed: Oct. 20, 2010

(30) Foreign Application Priority Data
Nov. 24, 2009 (KR) 10-2009-0113858

(51) Int. Cl. H04N 7/167

(52) U.S. Cl. 380/200

(57) ABSTRACT

An apparatus for video encryption by randomized block shuffling according to an embodiment of the present invention includes: a random number and key manager that stores a key shared between a video encryption apparatus and a video decryption apparatus and generates a random number by using the key; and a block shuffling processor that analyzes encoded video data, classifies the encoded video data in accordance with a predetermined rule, generates a shuffling group in accordance with classification information, and changes positions of components in the shuffling group in accordance with the shuffling rule generated by using the random number generated by the random number and key manager.

### CROSS REFERENCE TO RELATED APPLICATIONS

This application claims priority to Korean Patent Application No. 10-2009-0113858 filed on Nov. 24, 2009, the entire contents of which are herein incorporated by reference.

### BACKGROUND OF THE INVENTION

1. Field of the Invention

The present invention relates to an apparatus and a method for encrypting video data, and more particularly, to an apparatus and a method that prevent an unauthorized user from acquiring useful information in spite of illegally acquiring video data while data is transmitted or stored through a network.

2. Description of the Related Art

A method for encrypting video data includes a method for encrypting all video data by using a standard encryption algorithm or a method for selectively encrypting only some key data of the video data.

The latter method is referred to as selective encryption or partial encryption. Since the selective encryption encrypts only some of the video data, it has processing performance better than encrypting all the video data. Further, since encrypted data can satisfy a video standard specification, the selective encryption method is generally used.

The selective encryption encrypts residual data and a motion vector which are key elements among the video data. The encryption may be included in a video encoding process and may target video data generated after the encoding. The video encoding process may be largely divided into an entropy coding-prior step and an entropy coding step. When encryption is performed before entropy coding, video compression rate is decreased. Therefore, in order to prevent the problem, the encryption is performed at the entropy coding step. In addition, in the case in which a video codec has already been installed, thus, an encryption function is difficult to add to the codec, grasping and encrypting key information among the video data generated after encoding is also a good method.

After determining the key information in the video data, a random number is generated in order to encrypt the key information and thereafter, a method of XOR-operating the corresponding data and the random number is generally used. Since a value is changed through the XOR operation, but the position of the element is not changed, useful information can be acquired without fully decrypting the information in terms of characteristics of the video codec. When signs of the coefficients can be accurately known even though all coefficients generate through discrete cosine transform are encrypted, it is possible to know contour information of an image. Therefore, since only signs of the coefficients are accurately inferred without accurately decoding all the coefficients, it is possible to acquire desired information through much lower efforts than attack for decoding all the coefficients. These problems are generated because only values are changed without changing positions of elements to be encrypted during the encryption.

Each of the coefficients generated through the discrete cosine transform does not express one pixel, but only when coefficients constituting blocks should be collected, pixels in the block may be configured.

The position of the coefficient in the block is important in order to accurately reconfigure the block, as well as the value of each coefficient. Therefore, since the position, which is one of the important information, does not change, the attack becomes easier. A method of changing the position per block has been proposed, but even though the position of the block is changed, the positions of the coefficients in the block are not changed. Therefore, the problems cannot be completely solved. In addition, although a method of changing the positions of the coefficients before entropy coding has been proposed, another problem such as a decrease of video compression rate is caused. The prior art of changing only some values of the video data is vulnerable to the attack and a method of additionally adopting the change of the position also cannot completely overcome the vulnerability or causes another problem such as the decrease in the compression rate, and, as a result, the prior art and the method are insufficient to ensure the security of the encrypted video data.

In the existing proposed shuffling method, all data corresponding to each block are shifted in order to change the position of the block. In this case, information on the values and positions of the coefficients are maintained as it is and the security is deteriorated in the case in which the number of blocks of which the positions will be exchanged with each other is small.

### SUMMARY OF THE INVENTION

An object of the present invention is to provide an apparatus and a method for encrypting video data, which are capable of more safely managing the video data.

Another object of the present invention is to provide an apparatus and a method capable of preventing video information from being illegally acquired.

Yet another object of the present invention is to provide an apparatus and a method capable of recovering original video data by only an authorized user's regenerating a change rule.

Still another object of the present invention is to provide an apparatus and a method capable of preventing video data from being illegally used.

In order to achieve the above-mentioned objects, a video data encryption apparatus according to an aspect of the present invention changes positions of coefficients in a block while changing positions of blocks constituting video data.

The video data encryption apparatus according to the aspect of the present invention generates groups of which positions will be exchanged with each other in order to conform to a video codec standard even after changing the positions and minimizing performance deterioration due to the positional change.

The video data encryption apparatus according to another aspect of the present invention generates a rule to be applied for a positional change in each group on the basis of random numbers.

According to yet another aspect of the present invention, there is a video data encryption apparatus includes: a random number and key manager that stores a key shared between a video encryption apparatus and a video decryption apparatus and generates a random number by using the key; and a block shuffling processor that analyzes encoded video data, classifies the encoded video data in accordance with a predetermined rule, generates a shuffling group in accordance with classification information, and changes positions of components in the shuffling group in accordance with the shuffling rule generated by using the random number generated by the random number and key manager.

In the video data encryption apparatus according to yet another aspect of the present invention, the random number and key manager includes: a key management unit that stores the key shared between the video encryption apparatus and the video decryption apparatus; and a random number generation unit that generates the random number by using the key.

In the video data encryption apparatus according to yet another aspect of the present invention, the block shuffling processor includes: a block information collection unit that collects information constituting each block by analyzing encoded video data, classifies the collected information as components in accordance with a predetermined condition, and stores the corresponding information; a shuffling group generation unit that generates the shuffling groups of which positions will be exchanged with each other on the basis of the information classified by the block information collection unit; a shuffling rule generation unit that generates a shuffling rule by using the random number; and a shuffling execution unit that changes positions of components in the shuffling group in accordance with the shuffling rule generated by the shuffling rule generation unit.

In the video data encryption apparatus according to yet another aspect of the present invention, the block information collection unit that classifies the information constituting each block into a value element and a position element by analyzing the encoded video data.

In the video data encryption apparatus according to yet another aspect of the present invention, the position element is classified as an element representing an approximate position and an element representing an accurate position.

According to an aspect of the present invention, there is provided a method for video encryption by randomized block shuffling that includes: generating shuffling groups of which positions will be exchanged with each other among video data components; generating a shuffling rule for the positional change in each shuffling group; and changing the positions between the components in each shuffling group in accordance with the generated shuffling rule.

In the method for video encryption by randomized block shuffling according to the aspect of the present invention, the generating shuffling groups includes: collecting information of each block and an adjacent block thereto when video data is processed per block; classifying data constituting each block as an element expressing a value of a coefficient and an element expressing a position of a coefficient in the block; and classifying the elements expressing the value of the coefficient and the elements expressing the position of the coefficient in the block into groups, respectively, with respect to various blocks.

In the method for video encryption by randomized block shuffling according to the aspect of the present invention, the collecting information acquires an average value of the number of coefficients having positive numbers in an upper block and the number of coefficients having positive numbers in a left block.

In the method for video encryption by randomized block shuffling according to the aspect of the present invention, the classifying the elements classifies, in a block encoded in a CAVLC scheme, information on trailingones and level as elements expressing values of the coefficients and information on totalzeros and run_before as elements expressing positions of the coefficients.

In the method for video encryption by randomized block shuffling according to the aspect of the present invention, the classifying the elements into groups classifies elements having the number of coefficients having positive numbers and the same size in the block into one group.

In the method for video encryption by randomized block shuffling according to the aspect of the present invention, the classifying the elements into groups classifies elements having the same average value between the number of the coefficients having positive numbers in the left block and the number of the coefficients having positive numbers in the upper block, the same number of coefficients having positive number in the block, and the same size as one group.

In the method for video encryption by randomized block shuffling according to the aspect of the present invention, the generating a shuffling rule includes: generating random numbers as many as the number of components constituting the shuffling group; relating the generated random numbers to the components; and determining changed positions of the components by sorting the random numbers.

As described above, an apparatus and a method for video encryption by randomized block shuffling according to an embodiment of the present invention can have the following effects:

First, the present invention prevents au unauthorized user from acquiring useful information in spite of illegally acquiring video data.

Second, the present invention provides more improved security than a known video encryption method.

Third, the present invention can be widely applied to various fields.

### BRIEF DESCRIPTION OF THE DRAWINGS

FIG. 1 is a block diagram showing a schematic configuration of an apparatus for video encryption by randomized block shuffling according to the present invention;

FIG. 2 is a flowchart showing a process of generating shuffling group of which positions will be exchanged with each other among video data components;

FIG. 3 is an exemplified diagram of configurations of shuffling groups of which positions will be exchanged with each other according to an embodiment of the present invention;

FIG. 4 is an exemplified diagram of a shuffling rule generated based on random numbers according to an embodiment of the present invention; and

FIG. 5 is an exemplified diagram showing a change of a position of a block according to an embodiment of the present invention.

### DETAILED DESCRIPTION OF THE PREFERRED EMBODIMENTS

Hereinafter, the present invention will be described in detail with reference to the accompanying drawings. Herein, the detailed description of a related known function or configuration that may make the purpose of the present invention unnecessarily ambiguous in describing the present invention will be omitted. Exemplary embodiments of the present invention are provided so that those skilled in the art may more completely understand the present invention. Accordingly, the shape, the size, etc., of elements in the figures may be exaggerated for explicit comprehension.

In order to improve understanding of a configuration of the present invention, an H.264 video codec will be described as a target.

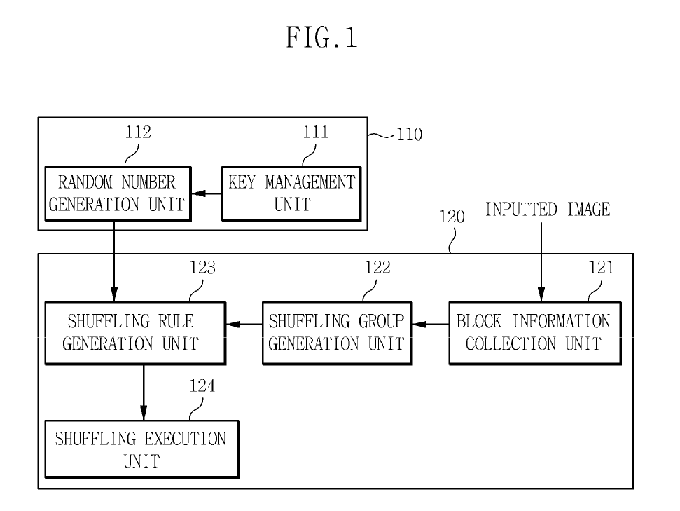

FIG. 1 is a diagram showing a configuration of an apparatus for video encryption by randomized block shuffling according to the present invention. As shown in the figure, the randomized block shuffling apparatus 100 for video encryption according to the embodiment of the present invention includes a random number and key manager 110 and a block shuffling processor 120.

The random number and key manager 110 includes a key management unit 111 storing a key shared between a video encryption apparatus and a video decryption apparatus and a random number generation unit 112 generating a random number by using the key.

Meanwhile, the block shuffling processor 120 includes a block information collection unit 121 that analyzes encoded video data, collects information constituting each block, classifies the collected information into components according to a predetermined condition, and stores the corresponding information, a shuffling group generation unit 122 that generates shuffling groups of which positions will be exchanged with each other on the basis of the information classified by the block information collection unit 121, a shuffling rule generation unit 123 that generates a shuffling rule by using the random number, and a shuffling execution unit 124 that changes positions of components in the shuffling group in accordance with the shuffling rule generated by the shuffling rule generation unit 123.

The block information collection unit 121 analyzes the encoded video data and classifies the information constituting each block into a value element and a position element. According to circumstances, the position element may be classified into an element representing an approximate position and an element representing an accurate position.

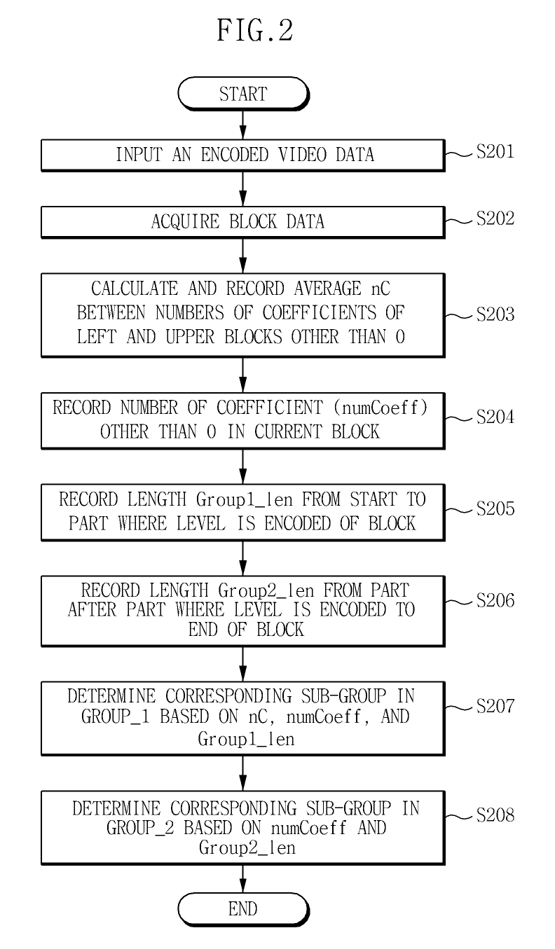

FIG. 2 is a flowchart showing a process of analyzing encoded data and generating shuffling groups of which positions will be exchanged with each other among video data components and functions of the block information collection unit 121 and the shuffling group generation unit 122 will be described in detail by using the flowchart.

When encoded video images are inputted (S201), data corresponding to each block in an encoded bit stream is acquired (S202).

The size of the block defined in H.264 is 4×4 and each block is encoded in a context adaptive variable length coding (CAVLC) scheme. The CAVLC scheme largely classifies information on each block into the following three types.

For example, the information is classified into the number of coefficients (numCoff) constituting each block other than 0, values of the coefficients (trailing ones and level) other than 0, and a position of each coefficient in the block (total zones and run before). In addition, when three pieces of information are sequentially encoded, a bitstream encoding the block is generated.

The CAVLC scheme uses a scheme to maximally increase compression rate by using information of an adjacent block without encoding the block by using only the information in each block. That is, the CAVLC scheme selects the most efficient code table by using the information on the adjacent block and encodes the block by using the table. Accordingly, when the position of the block is changed, a code table used to decode the corresponding block may depend on the adjacent block. When a code table different from the code table used in encoding is used, an error may occur. This does not conform to the gist to make the encrypted video data conform to a video standard. Therefore, special attention should be paid to generating the shuffling groups of which the positions will be exchanged with each other.

The information of the adjacent block used in the CAVLC scheme is the number of the coefficients constituting the block other than 0. An average value of the numbers of coefficients of left and upper blocks which are firstly encoded among the adjacent blocks, which are other than 0 is acquired and as a result, a code table to be used in encoding is determined. The resulting acquired average number of the coefficients other than 0 is represented by nC and information on nC is acquired and recorded for each block (S203).

The blocks encoded by the CAVLC scheme may be divided into two groups in terms of their characteristics. Limitations of the known method can be overcome by independently shuffling the two groups. The two groups are called Group_1 and Group_2. Encoding information for the values (trailing ones and level) of the coefficients other than 0 is included in Group_1 and information on the position (total zones and run before) of each coefficient in the block is included in Group_2.

Group_1 includes relative position information between the value of the coefficient in the block and the coefficient other than 0 and Group_2 includes position information of coefficients in the block. Since the block cannot be accurately reconfigured by using only the relative position information between the coefficients other than 0, the information included in Group_2 is required. Therefore, when a shuffling group for each of Group_1 and Group_2 is generated targeting several blocks and a positional change is made in each shuffling group, the security is markedly improved in comparison with the method in which the shuffling group is generated and the positional change is made per block. The reason therefore is that when the shuffling rule is not known, the number of cases for finding an accurate position of each of Group_1 and Group_2 constituting one block is much more than the number of cases for determining an accurate position of each block.

However, when one shuffling group constituted by Group_1s of the blocks and one shuffling group constituted by Group_2s of the blocks are generated and the positional change is made without a constraint within each shuffling group, processing performance may become a problem. The reason is that in the case of encoding through the CAVLC scheme, data corresponding to each group is discriminated not per byte but per bit. Two components of the shuffling group constituted by the Group_1s are set as A and B. In the case in which the size of A is larger than the size of B, A is shifted to the position of B. In this case, since an original space occupied by B is not sufficient, all bitstreams after B should be shifted by a difference in size between A and B. This may cause the performance problem because large data is processed per bit. Accordingly, it is preferable that a sub-group is generated using components having the same size in each shuffling group and the positional change is made in only the sub-group.

For this, recording the size from the start of the block to a part where a level is encoded (S205) and recording the size from a part after the level-encoded part to the end (S206) are required.

In addition, even after each group in the block is shuffled, additional constraints are required at the time of generating the sub-group in order to conform to the video codec standard. Group_1 should generate a sub-group constituted by components having the same nC, numCoeff, and size and collects information required to generate the sub-group (S207). Group-2 should generate a sub-group constituted by components having the same number of coefficients other than 0 (numCoeff) and the same size and collects information required to generate the sub-group (S208).

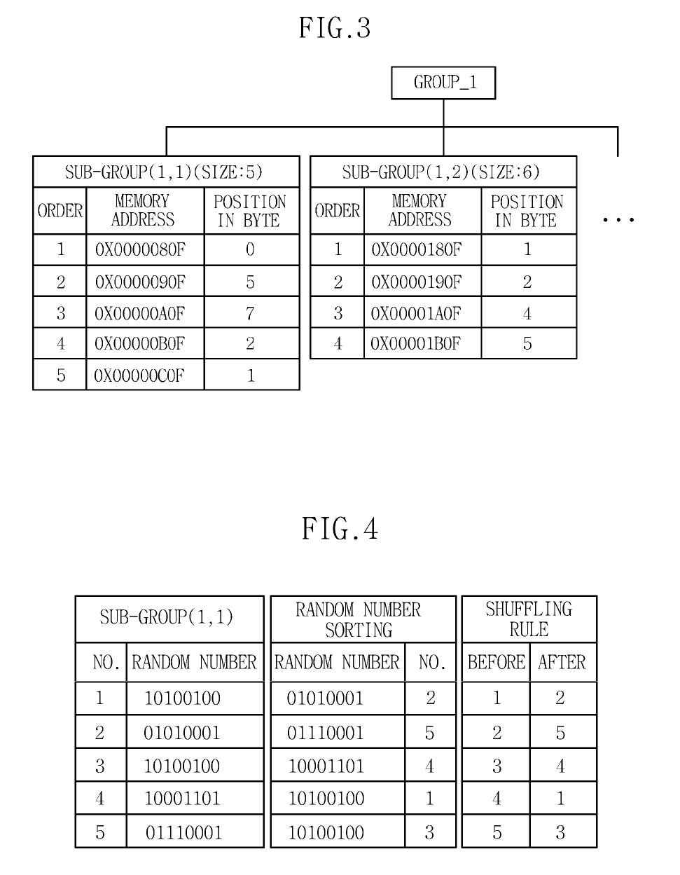

Configurations of the groups and the sub-groups will be described by using FIG. 3. FIG. 3 is an exemplified diagram of configurations of shuffling groups of which positions will be exchanged with each other according to an embodiment of the present invention. Components in each block are divided into components to belong to Group_1 and components to belong to Group_2, which are collected to constitute Group_1 and Group_2. Group_1 is divided into sub-groups in accordance with the above-mentioned constraint and thereafter, the positions of the components are changed by using the sub-groups as the shuffling group. In order to change the positions of the components, a memory address of each component and information that the n-th time bit starts in a first byte are required. Since the components constituting each server group have the same size, size information needs not to be maintained for each component. The size represents the number of bits constituting the component of the sub-group. Accordingly, a bitstream as large as the size starting from a predetermined bit in a byte corresponding to a memory address is information corresponding to the component of the sub-group. Each of the sub-groups generated as above serves as the shuffling group which is the unit to perform the positional change.

When the shuffling group is generated, the shuffling rule required for changing the positions of the components in each shuffling group should be generated. This will be described by using FIG. 4.

FIG. 4 is an exemplified diagram of a shuffling rule generated based on random numbers according to an embodiment of the present invention. When five components are provided in a sub-group (1,1), five random numbers are generated and allocated to the five components. When the size of the random number is increased, a probability that the same random number will be generated is preferably lowered, but a time may be delayed due to generation of the random number. Therefore, the random number is assumed as 8 bits. In addition, when the random numbers are sorted in the ascending order, a new order for the components can be acquired, such that positions of the components to be newly shifted can be found. Since the shuffling rule depends on the random number and a person who does not know the key cannot generate a required random number, unauthorized persons cannot know the shuffling rule.

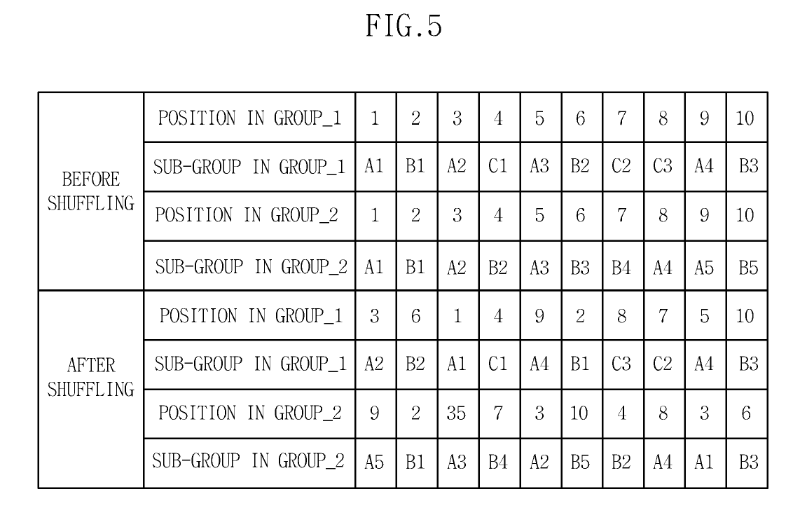

FIG. 5 is an exemplified diagram showing a positional change performed for each sub-group according to an embodiment of the present invention. Group_1 is divided into three sub-groups of A, B, and C. A is constituted by four components, B by three components, and C by three components. Group_2 is divided into two sub-groups of A and B. Since the number of constraints applied when the sub-groups are configured in Group_2 is smaller than that in Group_1, the number of the sub-groups of Group_2 is generally smaller than that of Group_1. According to the shuffling result, the positions of the components of each sub-group are changed and the components of Group_1 and Group_2 originally constituting one block do not constitute one block after shuffling.

Some steps of the present invention can be implemented as a computer-readable code in a computer-readable recording medium. The computer-readable recording medium includes all types of recording apparatuses in which data that can be read by a computer system is stored. Examples of the computer-readable recording media include a ROM, a RAM, a CD-ROM, a CD-RW, a magnetic tape, a floppy disk, an HDD, an optical disk, a magneto-optical storage device, etc., and in addition, include a recording medium implemented in the form of a carrier wave (for example, transmission through the Internet). Further, the computer-readable recording media are distributed on computer systems connected through the network, and thus the computer-readable recording media may be stored and executed as the computer-readable code by a distribution scheme.

As described above, the preferred embodiments have been described and illustrated in the drawings and the description. Herein, specific terms have been used, but are just used for the purpose of describing the present invention and are not used for defining the meaning or limiting the scope of the present invention, which is disclosed in the appended claims. Therefore, it will be appreciated to those skilled in the art that various modifications are made and other equivalent embodiments are available. Accordingly, the actual technical protection scope of the present invention must be determined by the spirit of the appended claims.

What is claimed is:

1. An apparatus for video encryption by randomized block shuffling, comprising:
a random number and key manager that stores a key shared between a video encryption apparatus and a video decryption apparatus and generates a random number by using the key; and
a block shuffling processor that analyzes encoded video data, classifies the encoded video data in accordance with a predetermined rule, generates a shuffling group in accordance with classification information, and changes positions of components in the shuffling group in accordance with the shuffling rule generated by using the random number generated by the random number and key manager.

2. The apparatus for video encryption by randomized block shuffling of claim 1, wherein the random number and key manager includes:
a key management unit that stores the key shared between the video encryption apparatus and the video decryption apparatus; and
a random number generation unit that generates the random number by using the key.

3. The apparatus for video encryption by randomized block shuffling of claim 1, wherein the block shuffling processor includes:
a block information collection unit that collects information constituting each block by analyzing encoded video data, classifies the collected information as components in accordance with a predetermined condition, and stores the corresponding information; and
a shuffling group generation unit that generates the shuffling groups of which positions will be exchanged with each other on the basis of the information classified by the block information collection unit.

4. The apparatus for video encryption by randomized block shuffling of claim 3, wherein the block information collection unit that classifies the information constituting each block into a value element and a position element by analyzing encoded video data.

5. The apparatus for video encryption by randomized block shuffling of claim 4, wherein the position element is classified as an element representing an approximate position and an element representing an accurate position.

6. The apparatus for video encryption by randomized block shuffling of claim 3, further comprising:
a shuffling rule generation unit that generates a shuffling rule by using the random number; and
a shuffling execution unit that changes positions of components in the shuffling group in accordance with the shuffling rule generated by the shuffling rule generation unit.

7. A method for video encryption by randomized block shuffling, comprising:
generating shuffling groups of which positions will be exchanged with each other among video data components;
generating a shuffling rule for the positional change in each shuffling group; and
changing the positions between the components in each shuffling group in accordance with the generated shuffling rule.

8. The method for video encryption by randomized block shuffling of claim 7, wherein the generating shuffling groups includes:
collecting information of each block and an adjacent block thereto when video data is processed per block;
classifying data constituting each block as an element expressing a value of a coefficient and an element expressing a position of a coefficient in the block; and
classifying the elements expressing the value of the coefficient and the elements expressing the position of the coefficient in the block into groups, respectively, with respect to various blocks.

9. The method for video encryption by randomized block shuffling claim 8, wherein the collecting information acquires an average value of the number of coefficients having positive numbers in an upper block and the number of coefficients having positive numbers in a left block.

10. The method for video encryption by randomized block shuffling claim 8, wherein the classifying the elements classifies, in a block encoded in a context adaptive variable length coding (CAVLC) scheme, the elements as elements expressing the number of coefficients other than 0, elements expressing values of the coefficients other than 0, and elements expressing positions of coefficients as positions of the coefficients in the block.

11. The method for video encryption by randomized block shuffling claim 8, wherein the classifying the elements into groups classifies elements having the number of coefficients having positive numbers and the same size in the block into one group.

12. The method for video encryption by randomized block shuffling claim 8, Wherein the classifying the elements classifies elements having the same average value of the numbers of the coefficients having positive numbers in a left block and in a upper block, the same number of coefficient having positive number in the block, and the same size as one another into one group.

13. The method for video encryption by randomized block shuffling claim 7, wherein the generating a shuffling rule includes:
generating random numbers as many as the number of components constituting the shuffling group;
relating the generated random numbers to the components; and
determining changed positions of the components by sorting the random numbers.
